(19) United States
(12) Patent Application Publication
(10) Pub. No.: US 2026/0228760 A1
(43) Pub. Date: Aug. 6, 2026

(54) SYSTEMS AND METHODS FOR USING SMALL TRANSFORMER MODELS IN FINANCIAL TRANSACTION UNDERSTANDING

(71) Applicant: JPMORGAN CHASE BANK, N.A., New York, NY (US)

(72) Inventors: Wanying DING, Sunnyvale, CA (US); Savinay NARENDRA, San Jose, CA (US); Xiran SHI, Mountain View, CA (US); Adwait RATNAPARKHI, San Jose, CA (US); Chengrui YANG, Milton Keynes (GB); Nikoo SABZEVAR, Chicago, IL (US); Ziyan YIN, West Chester, PA (US); Rebecca Jeanette-Paul SELA, Powell, OH (US); Matthew HOLTMAN, Swarthmore, PA (US); Anmol A KARNAD, Plainsboro, NJ (US)

(21) Appl. No.: 19/466,011

(22) Filed: Jan. 30, 2026

Related U.S. Application Data
(60) Provisional application No. 63/752,157, filed on Jan. 31, 2025.

(51) Int. Cl. G06Q 30/0201

(52) U.S. Cl. CPC G06Q 30/0201

(57) ABSTRACT

In some embodiments, the techniques described herein relate to systems and methods to identify merchants from noisy transaction data with low latency and cost. The method receives transaction text and a zipcode, applies rule-based matching, and upon failure uses enhanced string distance (ESD). If ESD fails, a transformer model is invoked: an encoder-only model that embeds transactions and merchant names for similarity ranking, or a decoder-based model that generates a canonical merchant name with a confidence score. Candidates are filtered using zipcode and text search, and a merchant is selected by combining the generated name or embeddings with similarity metrics. Verification integrates name similarity and model confidence, and, when thresholds are met, enhanced merchant information is stored in an enhanced transaction database. The approach improves accuracy and coverage for real-time transaction understanding while reducing rule maintenance and large-model burdens.

### RELATED APPLICATIONS

This application claims the benefit of U.S. Provisional Patent Application Ser. No. 63/752,157, filed Jan. 31, 2025. The disclosure of this application is hereby incorporated, by reference, in its entirety.

### BACKGROUND

### 1. Field of the Disclosure

Embodiments relate to systems and methods for using small transformer models in financial transaction understanding and modeling.

### 2. Description of the Related Art

The payments industry relies on accurate understanding of point-of-sale transactions to assess business risk, resolve customer inquiries, enhance user experience, and improve fraud detection. Merchant information embedded in transaction records is often messy, inconsistent, and expressed in diverse formats across merchants and acquirers, which complicates identification and standardization efforts. Unstructured and semi-structured text, frequent use of abbreviations and nicknames, and varying string formats introduce substantial noise that impedes reliable mapping from raw transaction text to a canonical merchant identity.

Conventional rule-based systems attempt to manage merchant identification by applying large sets of regular expressions and heuristic patterns. While such techniques can be effective for a limited number of known merchants, they are labor-intensive to create, modify, and maintain, and they do not scale to the vast array of unseen merchants and evolving formats. Enhanced string distance approaches provide broader coverage by ranking candidate merchants using string similarity and decision trees; however, these methods still fail to resolve a significant proportion of transactions, leaving many records unmanaged and contributing to poor user experience and costly call volumes.

These limitations are exacerbated in real-world environments characterized by extremely high data volumes and stringent latency requirements. In practice, systems may need to process tens of millions of transactions per day, with inference constrained to millisecond response times and tight cost budgets. Existing approaches that rely on heavyweight compute or extensive human rule maintenance cannot satisfy these throughput and latency constraints while maintaining high accuracy.

Transformer-based language models have demonstrated strong capabilities in natural language processing, including semantic normalization and pattern extraction. Pretrained large language models can be effective at capturing the linguistic variety of transaction strings, nicknames, and abbreviations. However, deploying large pretrained models in production introduces substantial computational and memory demands, which increase cost and latency. Moreover, pretrained models are not optimized for the specialized nuances of transaction data and often require domain-specific fine-tuning and careful prompt or architecture design, adding operational complexity. Confidentiality constraints further limit the use of hosted or external inference endpoints, necessitating models that can be deployed entirely within enterprise boundaries.

Domain-tailored small transformer models offer a promising alternative that balances accuracy, speed, and cost. By designing model architectures and tokenization strategies to reflect transaction-specific patterns and merchant naming conventions, such models can produce meaningful embeddings for merchant retrieval or generate canonical merchant names with associated confidence scores under strict latency budgets. Encoder-only models may support vector search workflows by encoding transactions and merchants into a shared embedding space for similarity-based ranking. Decoder-only and encoder-decoder models may generate standardized merchant names and confidence measures that can be combined with similarity scoring against a merchant database to select a final match.

In production pipelines, merchant candidate selection can be further refined using contextual filters such as transaction zip codes, followed by text search tools to narrow the candidate set before applying learned similarity or generation-based matching. Thresholding strategies that integrate model confidence with merchant name similarity help avoid erroneous identifications being surfaced to users. When used in conjunction with existing rule-based and enhanced string distance systems, small transformer models can increase coverage by addressing transactions that evade deterministic matching, thereby improving user experience and reducing inquiry-related costs.

Accordingly, there is a need for systems and methods that apply small, domain-optimized Transformer models within confidential, high-throughput financial processing environments to standardize merchant information from heterogeneous transaction texts. Such systems should deliver real-time accuracy under strict latency constraints, reduce operational costs associated with large pretrained models and manual rule maintenance, and integrate seamlessly with existing pipelines to expand coverage across complex transaction data.

### SUMMARY

Disclosed systems and methods describe a staged pipeline for merchant identification from noisy transaction text with zip code context and strict latency constraints. The systems and methods may include deterministic rule-based matching; if unsuccessful, a system or method may conduct enhanced string distance (ESD) matching. When ESD fails, a transformer-based stage may be invoked, using either an encoder-only model or a decoder-based model.

In the encoder-only path, the transaction text and merchant names may be encoded into a shared embedding space. Similarity metrics, such as cosine similarity, may be applied to select the closest merchant from a precomputed merchant embedding index. In the decoder-based path, the model may generate a canonical merchant name and a confidence score derived from token or sequence probabilities, which is then matched to database candidates via string similarity.

Candidate filtering may leverage the transaction zip code to reduce the search space and can include text search over constrained merchant subsets. Final verification may combine a name similarity score with the model's confidence score. Only when both exceed thresholds may the selected merchant confirmed and enhanced merchant information stored in an enhanced transaction database. The method may include real-time performance targets (e.g., under 100 milliseconds (ms) per transaction), supports presenting enriched merchant attributes to user interfaces, and emphasizes small model parameter counts to control cost and latency. Training provisions include constructing negative samples (e.g., via Jaccard similarity) for contrastive loss in encoder-only models and applying cross-entropy loss for decoder-based generation. Indexing strategies and thresholding logic are used to suppress erroneous predictions and ensure reliable end-user outputs.

Embodiments consistent with the present disclosure include a system including one or more processors and one or more storage devices storing instructions that when executed by one or more processors, cause the processor to perform one or more steps of the methods disclosed herein. Embodiments consistent with the present disclosure include a computer processing system, computer, or server, including: a memory configured to store instructions such as a non-transitory computer-readable storage medium; and a hardware processor operatively coupled to the memory for executing the instructions to perform one or more steps of the methods disclosed herein.

### BRIEF DESCRIPTION OF THE DRAWINGS

In order to facilitate a fuller understanding of the present disclosure, reference is now made to the attached drawings. The drawings should not be construed as limiting the present disclosure but are intended only to illustrate different embodiments.

FIG. 1 is a block diagram of a system for identifying merchants from noise transaction data under real-time constraints, in accordance with embodiments.

FIG. 2 is a method for identifying merchants from noise transaction data under real-time constraints, in accordance with embodiments.

FIG. 3 is a block diagram of a computing device for implementing certain Embodiments of the present disclosure.

### DETAILED DESCRIPTION

Embodiments are directed to systems and methods for using small transformer models in financial transaction understanding. For example, embodiments may identify a merchant name from transaction data, such as credit card transaction data. Embodiments may first use rule-based matching to identify a merchant from raw transaction data. If rule-based matching does not identify a merchant, embodiments may use enhanced string distance (ESD) matching to identify the merchant. If ESD matching does not identify a merchant, embodiments may use a transformer based model, such as a large language model or a transformer model, to identify the merchant.

The transformer model may be a decoder only model, an encoder-decoder model, or an encoder only model. The encoder-only model may produce transaction embedding vector based on the input transaction text. The model can also be used to transform merchant names into similar embedding vectors in the same embedding space. The model may then use a vector search to identify the most relevant merchant by using similarity measurement, such as cosine similarity, to identify a matching merchant. The decoder-only and encoder-decoder model may generate a merchant name and a model confidence score in the generated merchant name. The model may then use similarity matching with a database of merchant names to identify a matching merchant. This may also return a similarity score. If both of the similarity score and confidence score are above a threshold, the merchant information may be enhanced with additional data, and may be stored in an enhanced transaction database.

Embodiments achieve the technical benefit of providing users with more context for inquiries and fraud detection by transforming noisy transaction strings into standardized merchant identities in real time and enriching those identities with auxiliary attributes that are actionable at the point of investigation. The pipeline may include resolving a raw transaction to a canonical merchant name with an associated merchant identifier under strict latency budgets, which enables the system to surface the formal merchant name, logo, address, phone number, and related profile data within the user interface contemporaneously with the transaction post. This immediate standardization reduces ambiguity inherent in abbreviations, nicknames, and inconsistent formats, thereby lowering user uncertainty and the need for manual clarification.

Embodiments may further enhance context by constraining retrieval with geographic indicators and by verifying matches with quantitative signals. Zipcode-based filtering may reduce the candidate set to a location-consistent subset of merchants, and the system may compute a model confidence score and a name similarity score that are combined into a verification score prior to presentation. By applying acceptance thresholds, the system may suppress low-confidence outputs and avoids presenting incorrect merchant information, improving the reliability of contextual data attached to each transaction. When verifiable, the enriched record may be committed to an enhanced transaction database and returned to the client, where the standardized attributes are displayed as part of the transaction detail view to assist users in recognizing legitimate charges.

For fraud detection, disclosed systems and methods may provide structured features derived from the same resolution process that are not available from raw strings alone. The standardized merchant identifier enables aggregation of historical activity at the merchant level, facilitating time-series analysis of spending patterns, detection of sudden spikes, and profiling of typical transaction descriptors associated with a merchant. The verification signals, including the confidence score, the name similarity score, and/or the margin between top candidates, may become input features for downstream risk models, allowing those models to weigh how well a transaction conforms to learned merchant patterns. Location coherence may be enforced through zipcode filtering and can be cross-checked against user device geolocation and/or account home region to identify geographic anomalies. Because the encoder-decoder path captures domain-specific semantics, including common abbreviations and aliases, the system may more reliably distinguish between similarly named merchants, reducing false positives and improving the precision of risk alerts.

The architecture may increase coverage of previously unmanaged transactions by cascading from deterministic rules to learned models, thereby standardizing a larger portion of daily transaction volume. Increased coverage may translate into more transactions with complete merchant context, which reduces call center inquiries triggered by unrecognized descriptors and improves automated triage. In addition, the enhanced database stores the canonical merchant name, selected merchant identifier, verification scores, and/or auxiliary attributes, creating an auditable record that supports post-incident analysis and iterative threshold tuning. This persistence allows subsequent investigations to reference consistent, normalized merchant information rather than reprocessing heterogeneous strings.

Operationally, real-time inference at millisecond-scale latency may ensure that contextual details are available when they are most useful for both users and automated systems. The decoder-only path, the encoder-only path, and/or the encoder-decoder path may achieve a balance of accuracy and speed, while confidence-aware routing escalates to higher-accuracy generation when needed. By ensuring that only verified matches are surfaced and/or by enriching verified matches with standardized attributes, embodiments may deliver actionable, trustworthy context at the moment of inquiry and provide discriminative signals that materially improve fraud detection performance.

Embodiments may provide technical benefits by dynamically choosing among encoder-only, decoder-only, and encoder-decoder models to minimize manual input, increase response speed, and deliver accurate, verifiable results compared to traditional rule-based or static similarity systems. The adaptive selection may reduce manual input by automating resolution for heterogeneous, noisy transaction strings that previously required extensive human-crafted regex rules and continual maintenance. The encoder-only path may convert transactions and merchant names into embeddings for rapid vector retrieval, eliminating the need for hand-tuned pattern logic; the decoder-only and encoder-decoder paths may generate canonical merchant names from raw text, normalizing abbreviations, nicknames, and inconsistent formats without human intervention.

Choosing between models may increase response time performance by routing each transaction to the most efficient architecture under system constraints (e.g., bandwidth, computational processing availability, server access). The encoder-only model may achieve single-digit millisecond retrieval when similarity signals are strong, enabling immediate decisions for clear cases. The encoder-decoder model may leverage parallelizable encoding and fewer autoregressive steps to meet sub-100 millisecond service levels at scale. In some embodiments, the system may escalate to decoder-only generation for difficult cases where maximum normalization accuracy is needed. This cascade may preserve low latency for the majority of transactions while reserving higher compute for ambiguous inputs, thereby improving end-to-end throughput over traditional pipelines that either rely on slow, monolithic models or fall back to manual review when rules miss.

Disclosed system and methods may provide accurate and verifiable results by combining model-specific outputs with quantitative indicators. Decoder-based models may emit a canonical merchant name and a confidence score derived from sequence or token probabilities and encoder-based retrieval may provide embedding similarity and top-k margins. The system may integrate these indicators with zipcode-constrained candidate filtering and name similarity scoring to form verification thresholds that suppress incorrect matches before results are surfaced. Compared to static rule systems, which can misfire on unseen, problematic formats and/or mistakes, and basic string distance methods, which may overfit to lexical similarity without semantic normalization, this multi-model verification produces higher precision and robust generalization to new merchants and formats. By replacing brittle manual rules with an adaptive, indicator-driven cascade, embodiments disclosed herein reduce human maintenance overhead, accelerate decision-making at production scale, and deliver trustworthy, standardized merchant context. This yields fewer unresolved transactions, faster user-facing experiences, and stronger fraud detection features grounded in validated matches rather than heuristic approximations.

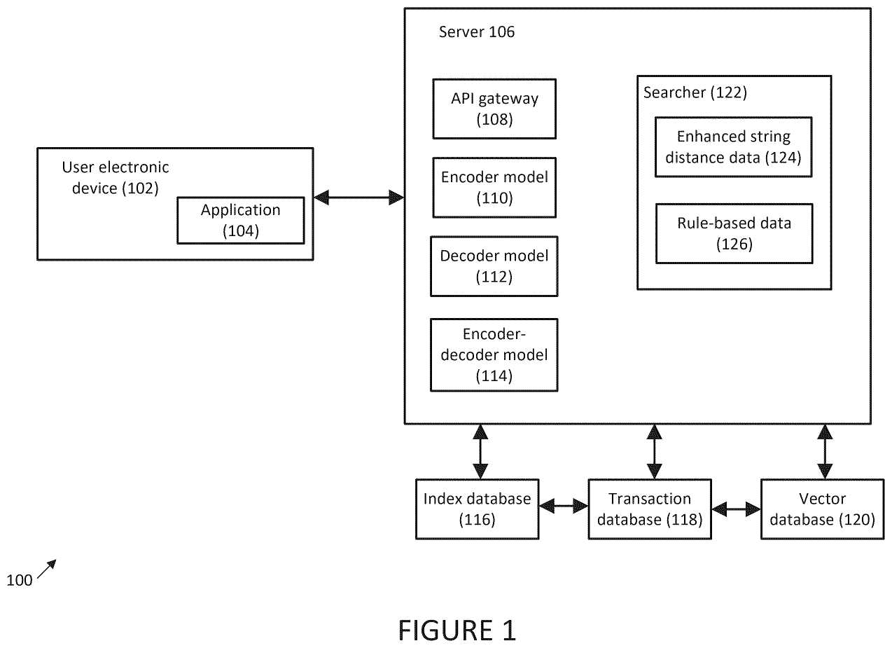

FIG. 1 illustrates a system for identifying merchants from noisy transaction data according to an embodiment.

A user electronic device 102 executes an application 104 that may transmit transaction information, including transaction text and contextual data such as zip code, to a server 106 via secure communication. The server 106 may include an API gateway 108 that receives requests from application 104, orchestrates processing, and returns standardized merchant outputs and associated metadata.

Within the server 106, an encoder model 110, a decoder model 112, and/or an encoder-decoder model 114 may be available as selectable transformer-based components depending on pipeline stage and configuration. Other embodiments are also disclosed herein. The encoder model 110 encodes transaction text and merchant names into embedding vectors for similarity-based retrieval, enabling vector search and ranking against a merchant index. The decoder model 112 may generate a canonical merchant name from messy transaction text and produces a confidence score indicative of generation reliability. The encoder-decoder model 114 may use a similar merchant name pipeline as the decoder model 112 and may include an additional encoding step. The encoding step may include one or more layers of encoders to transform a transaction into a context representation. The encoder-decoder model 114 may then use a similar number off layers of encoders on the context representation, instead of transaction tokens, to generate output.

A searcher 122 performs candidate retrieval and ranking using zip code-constrained filtering, text search, and similarity measures. The server 106 interacts with three persistent data stores: an index database 116 that maintains merchant name indices used for text search and candidate narrowing; a transaction database 118 that stores raw transaction records, intermediate processing results, and enhanced transaction outputs; and a vector database 120 that stores precomputed merchant embeddings and transaction embeddings used by the encoder model 110 for similarity matching.

Operation proceeds as follows. The application 104 on the user electronic device 102 submits transaction text to the API gateway 108. The server 106 optionally applies rule-based matching to create rule-based data 126 and enhanced string distance data 124 ranking using the searcher 122 over candidates selected from the index database 116, constrained by zip code. If deterministic methods do not resolve a merchant, the pipeline may invoke the encoder model 110, the decoder model 112, and/or the encoder-decoder model 114. In the encoder path, the encoder model 110 produces a transaction embedding, which is compared against merchant embeddings stored in the vector database 120 using similarity metrics, such as cosine similarity, to rank candidate merchants. In the decoder path, the decoder model 112 and/or encoder-decoder model 114 may generate a canonical merchant name and a model confidence score; the searcher 122 then performs a text search over the index database 116 to retrieve candidates and computes a name similarity score between the generated canonical merchant name and candidate names. The system 100 may verify the top candidate using combined indicators, including the model confidence score from the decoder model 112 and the name similarity score from the searcher 122, and may apply threshold criteria to suppress erroneous predictions. Upon verification, enhanced merchant information, such as standardized merchant name, logo, address, phone number, and merchant identifier, is stored in the transaction database 118 and returned to application 104.

In some embodiments, the transformer model may operate on cases where little string similarity exists between a transaction text and a merchant name. Table 1 provides financial transaction examples:

TABLE 1

| | Transaction | Merchant | Merchant |
|---|---|---|---|
| Transaction Text | Zip Code | ID | Name |
| RO * HM SP NTW P2FJOC4 | 12345 | XYZ001 | Shopping |
| | | | Network |
| AUTOMA SOFT * CORP008 | 67890 | XYZ002 | Software Co. |
| NCA * EARLYBRD | 13579 | XYZ003 | Northcoast |
| XQQJWQ9V4F4 | | | Air |
| DOL EXP LDGX | 24680 | XYZ004 | Dollar |
| ADV * ADSJLOCZ1DN | 98765 | XYZ005 | Advantage |
| | | | Ads |

As illustrated in Table 1, numerous transactions lack obvious sub-strings to identify the merchants. For instance, “NCA * EARLYBRD XQQJWQ9V4F4” is difficult to associate with “Northcoast Air”. Furthermore, transactions often include various types of noise, such as aggregators (third-party payment processors that facilitate online transactions) like “RO (Round)”, but there is no consistent pattern for where and how these aggregators will appear. In this case, Round may be a payment processing company. Additionally, the presence of transaction numbers makes it more challenging for a simple model to accurately associate transaction text with a specific merchant. For instance, in “DOL EXP LDGX,” the segment “LDGX” is a transaction number rather than part of the merchant's name. Disclosed systems and methods provide two components: a set of regular expression rules (e.g., rule-based) and an Enhanced String Distance (ESD) method, which utilizes string similarity measures in conjunction with a manual decision tree. A plurality (e.g., thousands) of regular expression rules may map incoming transactions to their corresponding merchant IDs. This method may only cover a relatively small number of merchants (e.g., less than one percent). Increasing rules along is highly unscalable and requires significant effort to create, modify, and maintain rules. On the other hand, the ESD method is more flexible and can cover a larger number of merchants. However, the ESD method currently only covers less than 20% of transactions, leaving a significant amount of transactions unmanaged. These transactions lead to poor user experiences and numerous transaction inquiry calls. Thus, the encoder model 110, decoder model 112, and/or encoder-decoder model 114 may be invoked to resolve merchant names consistent with disclosed methods.

The architecture in FIG. 1 supports high-volume, low-latency processing by enabling selective invocation of the encoder model 110 for fast similarity-based retrieval and the decoder model 112 for generative normalization when needed, while leveraging zip code filters and index-based search through the searcher 122 to reduce candidate sets. The vector database 120 facilitates rapid embedding comparison and periodic index refreshes when the encoder model 110 is updated. The index database 116 supports stable text search operations for decoder outputs without requiring full vector reindexing. Indicators used by the system 100 include at least a model confidence score generated by the decoder model 112, a name similarity score computed by the searcher 122, and optional additional verification signals derived from embedding similarity in the encoder path. These indicators may be combined to form a verification score that governs whether enhanced merchant information is committed to the transaction database 118 and surfaced to the application 104 through the API gateway 108 on the server 106.

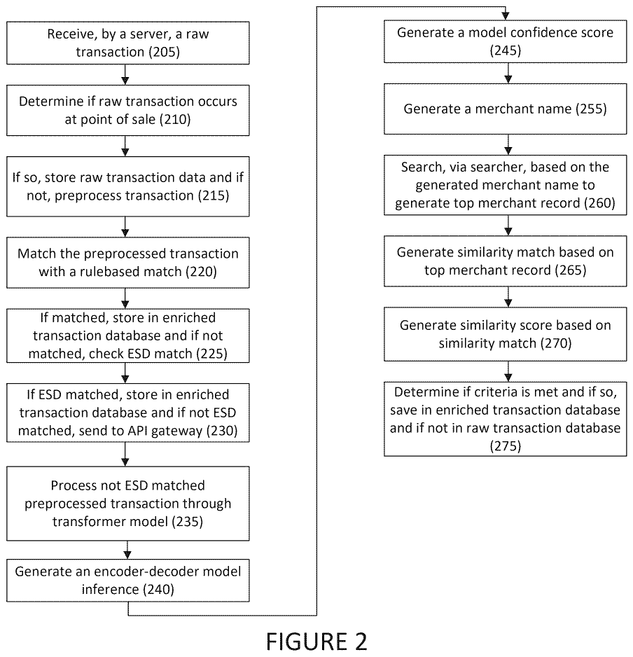

FIG. 2 illustrates a method for identifying merchants from noisy transaction data according to an embodiment.

FIG. 2 illustrates a transaction processing flow that standardizes merchant information from raw transaction data under real-time constraints, using rule-based logic, enhanced string distance techniques, and transformer-based inference, with verification via confidence and similarity indicators. The process begins when a server receives a raw transaction (205). The server determines whether the raw transaction occurs at point of sale (210). If the transaction is identified as a point-of-sale transaction, the raw transaction data is stored as received without further preprocessing at this stage (215). If the transaction is not a point-of-sale transaction, the server preprocesses the transaction (215) to normalize formatting and remove noise, such as converting to lowercase, stripping special symbols, and performing string cleaning steps suitable for merchant name analysis.

The preprocessed transaction is first matched using a rule-based engine (220) that applies curated regular expressions and pattern heuristics designed for known merchant formats. If a rule-based match is found, the system saves the standardized merchant information, including the merchant identifier and enriched attributes such as name, logo, address, and phone number, into an enriched transaction database (225), and the flow for that transaction ends. If the preprocessed transaction is not matched by the rule-based engine, the process evaluates enhanced string distance matching (225), which applies a similarity framework that combines distance metrics and decision trees to rank candidate merchants. If enhanced string distance matching succeeds, the enriched transaction record is saved to the enriched transaction database (230), and the flow ends. If enhanced string distance matching does not succeed, the server forwards the preprocessed transaction to an API gateway (230) that orchestrates inference requests to a transformer-based model.

The API gateway submits the preprocessed transaction to a Transformer model to process transactions that were not resolved by enhanced string distance matching (235). The model generates an encoder-decoder inference (240) that produces normalized outputs for downstream verification. In one implementation aligned with the invention disclosure, the model is an encoder-decoder architecture that first encodes the transaction into a context representation and then decodes to a merchant name sequence. As part of the inference, the system generates a model confidence score (245) indicative of the reliability of the decoded output, which may be derived from token-level or sequence-level probabilities. The decoded output includes a generated merchant name (255) that serves as a canonical string representation for candidate retrieval.

The system uses a searcher to perform a constrained lookup (260). The searcher applies zip code-based filtering to limit candidates to geographic-relevant merchants and then conducts text search over the filtered merchant corpus to generate a top merchant record. The system then computes a similarity match between the generated merchant name and the top merchant record (265), producing a similarity score (270) that quantifies the textual alignment between the decoded merchant name and the merchant database entry, which may include normalized variants and aliases.

The system assesses whether the criteria are met (275) by combining indicators, including the model confidence score generated at (245) and the similarity score generated at (270). Thresholds are applied such that only candidates with sufficient confidence and similarity are accepted as correct matches. If the combined indicators satisfy the criteria, the transaction is saved to the enriched transaction database (275), together with the standardized merchant identifier, the generated canonical name, the confidence score, the similarity score, and enriched attributes for downstream user experiences and fraud analysis. If the criteria are not met, the transaction is saved in the raw transaction database (275) for subsequent handling, which may include offline review, additional model iterations, or future rules expansion.

The method thus implements a layered resolution pipeline that first attempts deterministic rule-based matching (220), then applies enhanced string distance matching (225), and finally invokes a Transformer-based encoder-decoder inference (235, 240) coordinated through an API gateway. The search and verification stage integrates zip code-constrained candidate filtering and text search (260), similarity computation (265, 270), and indicator-based decision thresholds (275) to suppress erroneous predictions before committing results to the enriched transaction database. This architecture meets strict latency targets by resolving the majority of transactions using inexpensive deterministic methods, while the model-backed path handles complex cases and improves overall coverage, accuracy, and user experience.

Embodiments encompass multiple transformer model families, training regimes, datasets, tokenization choices, indexing strategies, and comparative performance analyses not depicted in FIGS. 1 and 2. Three architectural classes are contemplated: encoder-only, decoder-only, and encoder-decoder. In the encoder-only approach, both transactions and merchant names are embedded into a shared vector space, and candidate merchants are ranked by similarity (e.g., cosine similarity). Decoder-only and encoder-decoder approaches treat transaction understanding as a sequence generation task that outputs a canonical merchant name accompanied by a confidence score derived from token- or sequence-level probabilities; those outputs are subsequently matched to database candidates using string similarity measures within zip code-filtered pools.

Training objectives are model-specific. For encoder-only models, a contrastive objective is applied to separate matched transaction-merchant pairs from close non-matching pairs using a margin. The loss can be expressed as:

$$L = ( 1 - pos\_sim ) + max ( 0 , neg\_sim - margin ) \qquad ( 1 )$$

where pos_sim denotes the cosine similarity between a transaction and its true merchant, neg_sim denotes the cosine similarity between the same transaction and a selected hard negative merchant, and the margin is set to 0.5 in one embodiment. For decoder-based training, a token-level cross-entropy objective is applied:

$$L = - \frac{1}{N} {\sum }_{i = 1}^{N} \times {\sum }_{c = 1}^{C} \times {y}_{i , c} log ( {\hat{y}}_{i , c} ) \qquad ( 2 )$$

where N is sequence length, Cis vocabulary size, y is the one-hot target, and ŷ is the predicted distribution. Negative sampling for the encoder-only model uses Jaccard similarity to select difficult non-matches by choosing merchants with similarity greater than 0.75 and less than 1.0 relative to the true merchant.

Multiple datasets are considered for both training and evaluation. Historical transactions are partitioned into: rule-based data (approximately 63% of volume), enhanced string distance (ESD) data (approximately 17%), and raw-cleansed data (approximately 20%). A rule-based training set of 773,653 transactions covers 779 merchants, with a 1,311-transaction test set for the same merchants. An ESD-derived training set of 574,871 transactions covers 506,135 merchants, with two test sets: ESD_RD (40,223 transactions for seen merchants) and ESD ZS (10,000 transactions for unseen merchants). For raw-cleansed transactions lacking ground truth, 2,541 records are manually labeled for evaluation. A separate merchant corpus includes approximately 7.8 million records for matching. In one embodiment, Lucene is used to narrow candidates using zip code filters prior to semantic ranking or string matching. Evaluation uses a weighted accuracy reflecting production prevalence:

$$Weighted Accuracy = \text{.63} {A}_{Rule} + . 085 {A}_{ESD \_ RD} + . 085 {A}_{ESD \_ ZS} + . 20 {A}_{Raw} \qquad ( 3 )$$

The coefficients (0.63, 0.085, 0.20), are exemplary and may reflect percentage of a dataset as it relates to the total (e.g., 0.63+0.085+0.085+0.20=1.0) as discussed above. Decoder-only models are comparatively insensitive to tokenizer selection. Vocabulary size is not monotonically beneficial: encoder-only models achieve peak performance with a vocabulary of approximately 1,000 tokens, whereas decoder-only and encoder-decoder models perform best with smaller vocabularies of approximately 500 tokens. Subsequent experiments utilize an iterative subunit merger with a 1,000-token vocabulary for encoder-only models and byte-pair encoding with a 500-token vocabulary for decoder-only and encoder-decoder models.

Model size studies show that larger is not uniformly better. Varying embedding dimension from 16 to 1,024 and layer depth from 2 to 16 demonstrates that encoder-only models benefit from larger width and depth up to a point, peaking around a 512-dimensional embedding and about 8 layers, after which accuracy declines. Decoder-only models improve up to roughly a 256-dimensional embedding and then degrade, consistent with overfitting or noise amplification at larger sizes; they are relatively stable across layer counts. Encoder-decoder models are robust across a range of widths and depths, with a slight accuracy increase up to approximately a 128-dimensional embedding and modest variance with depth. These results indicate that architecture-specific size sweet spots exist for the transaction understanding task.

Comparative evaluations of open-source pretrained models and small models trained from scratch show that small, domain-optimized models can match or exceed the accuracy of larger pretrained models while dramatically improving latency and cost. In one embodiment, a decoder-only model with approximately 1.7 million parameters achieves a weighted accuracy near 72.07% with an inference time of about 95.02 milliseconds per transaction, whereas a larger decoder-only model with approximately 8 billion parameters achieves approximately 72.89% weighted accuracy but requires approximately 735 milliseconds per transaction. An encoder-decoder model with approximately 1.5 million parameters achieves approximately 70.14% weighted accuracy and approximately 26.50 milliseconds per transaction, outperforming a larger encoder-decoder baseline near 68.31% accuracy. Encoder-only models demonstrate the fastest inference, on the order of single-digit milliseconds per transaction, but exhibit lower accuracy relative to decoder-based models due to close-name confusion and noise in raw strings. Training and inference costs estimated on commodity GPU instances show orders-of-magnitude savings for small models; for example, training times per one million transactions can be under one hour on a single mid-range GPU, and inference costs per one million transactions are substantially lower than those of large pretrained models. Indexing overhead differs by architecture: encoder-only deployments require periodic re-computation of merchant embeddings and vector indices, which can be time-consuming (e.g., on the order of tens of hours for full reindexing), whereas decoder-based deployments only maintain a stable text search index and are updated quickly (e.g., minutes) when the model changes.

Further experiments clarify architecture trade-offs. Although decoder-only models may achieve slightly higher accuracy than encoder-decoder models, the latter exhibit much faster inference under similar parameter budgets because fewer decoder layers are required and the encoding step is parallelizable. Encoder-decoder models therefore align better with stringent latency targets, such as sub-100 millisecond budgets for high-throughput environments exceeding 50 million transactions per day. Accuracy by dataset class reflects these trade-offs: encoder-decoder models exceed 90% on ESD-derived seen and unseen merchants, perform materially lower on complex rule-based transactions where business logic is better captured by deterministic rules, and achieve about 66% on raw-cleansed data, thereby significantly expanding coverage in segments previously unmanaged by deterministic systems.

Model selection may be selected by the among decoder-only, encoder-only, and encoder-decoder architectures is policy-driven to balance accuracy, latency, and cost under production constraints. The system routes transactions based on service-level objectives, transaction characteristics, and operational signals. When sub-100 millisecond end-to-end latency is required at very high volume, the encoder-decoder model may be selected by the application because it delivers competitive accuracy with faster inference due to parallelizable encoding and fewer autoregressive steps. If ultra-low latency pre-filtering is needed and accuracy tolerances permit, the encoder-only path may be selected by the application to perform rapid vector retrieval in single-digit milliseconds. For transactions whose lexical noise can be normalized, the decoder-only model may yield the highest accuracy by generating a coherent canonical name, while the encoder-decoder model typically achieves near-decoder accuracy at substantially lower cost and latency for ESD-like distributions. A routing application (e.g., of server 106) may consider candidate set size and contextual filters; with strong zipcode constraints, decoder-only generation can quickly disambiguate, whereas large or unconstrained candidate pools favor encoder-only embedding search before optional escalation. Confidence and similarity indicators may govern a cascade: the system may attempt encoder-only retrieval and accepts when similarity and margin thresholds are met; otherwise the system may escalate to encoder-decoder generation and verifies using model confidence and name similarity; if still marginal, the system may escalate to decoder-only for maximum accuracy. Historical performance by data class informs defaults: encoder-decoder for raw, messy transactions, decoder-only for corner cases with low encoder-decoder confidence, and retention of deterministic rule/ESD paths for rule-managed patterns. Resource availability and cost further adjust routing, favoring encoder-only for bulk pre-filtering under constrained GPU capacity and permitting decoder-only sweeps during off-peak windows. Tokenization and input complexity policies direct irregular or long strings toward decoder-based models, while inputs that would breach decoder-only latency are handled by encoder-decoder. Operational controls, including feature flags, A/B testing, and/or online threshold tuning based on dispute rates and user feedback, may continuously optimize the cascade to balance speed and accuracy in production.

Operational constraints and fine-tuning practices are accommodated by the disclosed embodiments. Confidentiality requirements prohibit sending transactions to external services; models are deployed on-premises or within controlled cloud environments. Pretrained open-source models may be fine-tuned using low-rank adaptation techniques, and decoder prompts are designed to emit only the merchant name. For example, one training prompt instructs emission of the merchant name given raw transaction text and zip code, and sequence-level supervision is provided during fine-tuning. Nevertheless, experimental results indicate that task-specific small models can exceed fine-tuned pretrained baselines in weighted accuracy at a fraction of the latency and cost.

Deployment combines learned and deterministic components to meet accuracy and service-level objectives. Deterministic rules and enhanced string distance matching handle predictable cases cheaply, while the learned model addresses complex cases. In production, an encoder-decoder model is favored to meet real-time requirements, with outputs post-processed through zip code-constrained search and verified using a combination of similarity and confidence indicators. The system persists the canonical merchant name, selected merchant identifier, and verification indicators and refrains from surfacing low-confidence predictions. This integrated approach reduces unmanaged transactions, minimizes inquiry-related costs, and improves user experience by presenting standardized merchant information such as formal names, logos, addresses, and/or phone numbers, to provide users with more context for inquiries and fraud detection within established latency and budget constraints. Specifically, identifying the corresponding merchant ID from messy transaction text and enhancing the merchant information, instead of displaying raw transaction information, presents detailed merchant information, such as the logo, cleaned name, address, phone number, etc., to provide users with more context for inquiries and fraud detection.

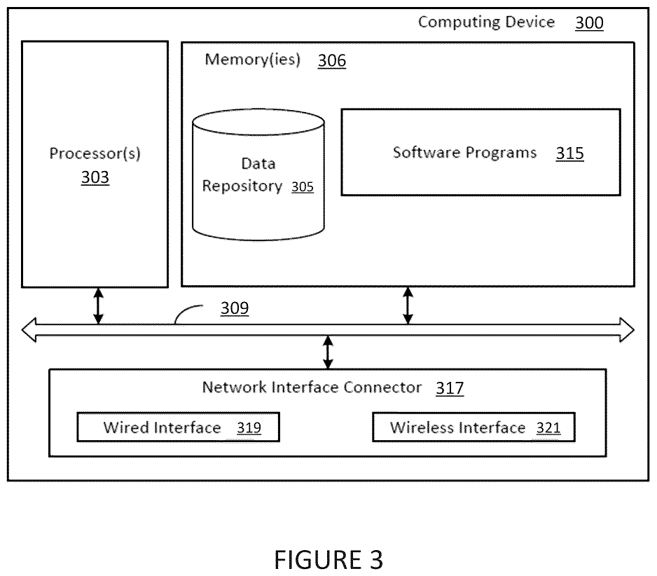

FIG. 3 depicts an exemplary computing system for implementing aspects of the present disclosure. FIG. 3 depicts exemplary computing device 300. Computing device 300 may represent the system components described herein. Computing device 300 may include processor 305 that may be coupled to memory 310. Memory 310 may include volatile memory. Processor 305 may execute computer-executable program code stored in memory 310, such as software programs 315. Software programs 315 may include one or more of the logical steps disclosed herein as a programmatic instruction, which may be executed by processor 305. Memory 310 may also include data repository 320, which may be nonvolatile memory for data persistence. Processor 305 and memory 310 may be coupled by bus 330. Bus 330 may also be coupled to one or more network interface connectors 340, such as wired network interface 342 or wireless network interface 344. Computing device 300 may also have user interface components, such as a screen for displaying graphical user interfaces and receiving input from the user, a mouse, a keyboard and/or other input/output components (not shown).

Hereinafter, general aspects of implementation of the systems and methods of embodiments will be described.

Embodiments of the system or portions of the system may be in the form of a “processing machine,” such as a general-purpose computer, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above. Such a set of instructions for performing a particular task may be characterized as a program, software program, or simply software.

In one embodiment, the processing machine may be a specialized processor.

In one embodiment, the processing machine may be a cloud-based processing machine, a physical processing machine, or combinations thereof.

As noted above, the processing machine executes the instructions that are stored in the memory or memories to process data. This processing of data may be in response to commands by a user or users of the processing machine, in response to previous processing, in response to a request by another processing machine and/or any other input, for example.

As noted above, the processing machine used to implement embodiments may be a general-purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA (Field-Programmable Gate Array), PLD (Programmable Logic Device), PLA (Programmable Logic Array), or PAL (Programmable Array Logic), or any other device or arrangement of devices that is capable of implementing the steps of the processes disclosed herein.

The processing machine used to implement embodiments may utilize a suitable operating system.

It is appreciated that in order to practice the method of the embodiments as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above, in accordance with a further embodiment, may be performed by a single component. Further, the processing performed by one distinct component as described above may be performed by two distinct components.

In a similar manner, the memory storage performed by two distinct memory portions as described above, in accordance with a further embodiment, may be performed by a single memory portion. Further, the memory storage performed by one distinct memory portion as described above may be performed by two memory portions.

Further, various technologies may be used to provide communication between the various processors and/or memories, as well as to allow the processors and/or the memories to communicate with any other entity; i.e., so as to obtain further instructions or to access and use remote memory stores, for example. Such technologies used to provide such communication might include a network, the Internet, Intranet, Extranet, a LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of embodiments. The set of instructions may be in the form of a program or software. The software may be in the form of system software or application software, for example. The software might also be in the form of a collection of separate programs, a program module within a larger program, or a portion of a program module, for example. The software used might also include modular programming in the form of object-oriented programming. The software tells the processing machine what to do with the data being processed.

Further, it is appreciated that the instructions or set of instructions used in the implementation and operation of embodiments may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments. Also, the instructions and/or data used in the practice of embodiments may utilize any compression or encryption technique or algorithm, as may be desired. An encryption module might be used to encrypt data. Further, files or other data may be decrypted using a suitable decryption module, for example.

As described above, the embodiments may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in embodiments may take on any of a variety of physical forms or transmissions, for example. Illustratively, the medium may be in the form of a compact disc, a DVD, an integrated circuit, a hard disk, a floppy disk, an optical disc, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by the processors.

Further, the memory or memories used in the processing machine that implements embodiments may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the systems and methods, a variety of “user interfaces” may be utilized to allow a user to interface with the processing machine or machines that are used to implement embodiments. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method, it is not necessary that a human user actually interact with a user interface used by the processing machine. Rather, it is also contemplated that the user interface might interact, i.e., convey and receive information, with another processing machine, rather than a human user. Accordingly, the other processing machine might be characterized as a user. Further, it is contemplated that a user interface utilized in the system and method may interact partially with another processing machine or processing machines, while also interacting partially with a human user.

It will be readily understood by those persons skilled in the art that embodiments are susceptible to broad utility and application. Many embodiments and adaptations of the present disclosure other than those herein described, as well as many variations, modifications and equivalent arrangements, will be apparent from or reasonably suggested by the foregoing description thereof, without departing from the substance or scope.

Accordingly, while the embodiments of the present disclosure have been described here in detail in relation to its exemplary embodiments, it is to be understood that this disclosure is only illustrative and exemplary of the present disclosure and is made to provide an enabling disclosure of the disclosure. Accordingly, the foregoing disclosure is not intended to be construed or to limit the present disclosure or otherwise to exclude any other such embodiments, adaptations, variations, modifications, or equivalent arrangements.

FIG. 3 is a block diagram of a computing device for implementing certain Embodiments of the present disclosure. FIG. 3 depicts exemplary computing device 300. Computing device 300 may represent hardware that executes the logic that drives the various system components described herein. For example, system components such as a user device, an interface, an event streaming platform, a matching algorithm, and various database/data store engines and servers, and other computer applications and logic may include, and/or execute on, components and configurations like, or similar to, computing device 300.

Computing device 300 includes a processor 303 coupled to a memory 306. Memory 306 may include volatile memory and/or persistent memory. The processor 303 executes computer-executable program code stored in memory 306, such as software programs 315. Software programs 315 may include one or more of the logical steps disclosed herein as a programmatic instruction, which can be executed by processor 303. Memory 306 may also include data repository 305, which may be nonvolatile memory for data persistence. The processor 303 and the memory 306 may be coupled by a bus 309. In some examples, the bus 309 may also be coupled to one or more network interface connectors 317, such as wired network interface 319, and/or wireless network interface 321. Computing device 300 may also have user interface components, such as a screen for displaying graphical user interfaces and receiving input from the user, a mouse, a keyboard and/or other input/output components (not shown).

The various processing steps, logical steps, and/or data flows depicted in the figures and described in greater detail herein may be accomplished using some or all of the system components also described herein. In some implementations, the described logical steps may be performed in different sequences and various steps may be omitted. Additional steps may be performed along with some, or all of the steps shown in the depicted logical flow diagrams. Some steps may be performed simultaneously. Accordingly, the logical flows illustrated in the figures and described in greater detail herein are meant to be exemplary and, as such, should not be viewed as limiting. These logical flows may be implemented in the form of executable instructions stored on a machine-readable storage medium and executed by a processor and/or in the form of statically or dynamically programmed electronic circuitry.

The system of the disclosure or portions of the system of the disclosure may be in the form of a “processing machine” a “computing device,” an “electronic device,” a “mobile device,” etc. These may be a computer, a computer server, a host machine, etc. As used herein, the term “processing machine,” “computing device, “electronic device,” or the like is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular step, steps, task, or tasks, such as those steps/tasks described above. Such a set of instructions for performing a particular task may be characterized herein as an application, computer application, program, software program, or simply software. In one aspect, the processing machine may be or include a specialized processor.

As noted above, the processing machine executes the instructions that are stored in the memory or memories to process data. This processing of data may be in response to commands by a user or users of the processing machine, in response to previous processing, in response to a request by another processing machine and/or any other input, for example. The processing machine used to implement the disclosure may utilize a suitable operating system, and instructions may come directly or indirectly from the operating system.

The processing machine used to implement the disclosure may be a general-purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA, PLD, PLA or PAL, or any other device or arrangement of devices that is capable of implementing the steps of the processes of the disclosure.

It is appreciated that in order to practice the method of the disclosure as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above may, in accordance with a further aspect of the disclosure, be performed by a single component. Further, the processing performed by one distinct component as described above may be performed by two distinct components. In a similar manner, the memory storage performed by two distinct memory portions as described above may, in accordance with a further aspect of the disclosure, be performed by a single memory portion. Further, the memory storage performed by one distinct memory portion as described above may be performed by two memory portions.

Further, various technologies may be used to provide communication between the various processors and/or memories, as well as to allow the processors and/or the memories of the disclosure to communicate with any other entity, i.e., so as to obtain further instructions or to access and use remote memory stores, for example. Such technologies used to provide such communication might include a network, the Internet, Intranet, Extranet, LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of the disclosure. The set of instructions may be in the form of a program or software. The software may be in the form of system software or application software, for example. The software might also be in the form of a collection of separate programs, a program module within a larger program, or a portion of a program module, for example. The software used might also include modular programming in the form of object-oriented programming. The software tells the processing machine what to do with the data being processed.

Further, it is appreciated that the instructions or set of instructions used in the implementation and operation of the disclosure may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various Embodiments of the disclosure. Illustratively, the programming language used may include assembly language, Ada, APL, Basic, C, C++, COBOL, dBase, Forth, Fortran, Java, Modula-2, Pascal, Prolog, REXX, Visual Basic, and/or JavaScript, for example. Further, it is not necessary that a single type of instruction or single programming language be utilized in conjunction with the operation of the system and method of the disclosure. Rather, any number of different programming languages may be utilized as is necessary and/or desirable.

Also, the instructions and/or data used in the practice of the disclosure may utilize any compression or encryption technique or algorithm, as may be desired. An encryption module might be used to encrypt data. Further, files or other data may be decrypted using a suitable decryption module, for example.

As described above, the disclosure may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in the disclosure may take on any of a variety of physical forms or transmissions, for example. Illustratively, the medium may be in the form of a compact disk, a DVD, an integrated circuit, a hard disk, a floppy disk, an optical disk, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by a processor.

Further, the memory or memories used in the processing machine that implements the disclosure may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the system and method of the disclosure, a variety of “user interfaces” may be utilized to allow a user to interface with the processing machine or machines that are used to implement the disclosure. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some Embodiments of the system and method of the disclosure, it is not necessary that a human user actually interact with a user interface used by the processing machine of the disclosure. Rather, it is also contemplated that the user interface of the disclosure might interact, i.e., convey and receive information, with another processing machine, rather than a human user. Accordingly, the other processing machine might be characterized as a user. Further, it is contemplated that a user interface utilized in the system and method of the disclosure may interact partially with another processing machine or processing machines, while also interacting partially with a human user.

It will be readily understood by those persons skilled in the art that the present disclosure is susceptible to broad utility and application. Many Embodiments and adaptations of the present disclosure other than those herein described, as well as many variations, modifications, and equivalent arrangements, will be apparent from or reasonably suggested by the present disclosure and foregoing description thereof, without departing from the substance or scope of the disclosure.

Accordingly, while the present disclosure has been described here in detail in relation to its exemplary Embodiments, it is to be understood that this disclosure is only illustrative and exemplary of the present disclosure and is made to provide an enabling disclosure of the disclosure. Accordingly, the foregoing disclosure is not intended to be construed or to limit the present disclosure or otherwise to exclude any other such Embodiments, adaptations, variations, modifications, or equivalent arrangements.

1. A method for identifying a merchant from transaction data, comprising:
receiving transaction text comprising unstructured or semi-structured merchant descriptors and a transaction zipcode;
applying rule-based matching to the transaction text to attempt to identify a merchant;
upon failure of the rule-based matching, applying an enhanced string distance matching procedure to attempt to identify the merchant;
upon failure of the enhanced string distance matching procedure, invoking a transformer model to identify the merchant, wherein the transformer model is selected from: (i) an encoder-only model that encodes the transaction text and merchant names into embedding vectors and ranks candidate merchants by a similarity metric, and (ii) a decoder-based model that generates a canonical merchant name with an associated model confidence score;
selecting a candidate merchant from a merchant database by combining, for the transformer model output, at least one of the generated canonical merchant name and the embedding vector with a candidate filtering process that includes a zipcode constraint;
verifying the selected candidate merchant using a similarity score between the generated canonical merchant name and the candidate merchant name and the model confidence score; and
upon meeting threshold criteria for the similarity score and the model confidence score, storing enhanced merchant information in an enhanced transaction database.

2. The method of claim 1, wherein the encoder-only model produces a transaction embedding vector and compares the transaction embedding vector against precomputed merchant embedding vectors using cosine similarity to select the candidate merchant.

3. The method of claim 1, wherein the decoder-based model comprises a decoder-only model or an encoder-decoder model that outputs a merchant name token sequence and the model confidence score derived from sequence-level or token-level probabilities.

4. The method of claim 1, wherein the candidate filtering process includes constraining candidates by the transaction zipcode and performing a text search over the constrained candidates before applying the encoder-only similarity ranking or the decoder-based generated merchant name matching.

5. The method of claim 1, wherein the threshold criteria include a similarity score threshold between the generated canonical merchant name and the candidate merchant name and a confidence score threshold produced by the transformer model.

6. The method of claim 1, further comprising presenting enhanced merchant information including at least one of a merchant logo, formal merchant name, merchant address, and merchant phone number to a user interface upon successful verification.

7. The method of claim 1, wherein the transformer model is configured for real-time inference within a latency budget of less than 100 milliseconds per transaction.

8. A system for financial transaction understanding, comprising:
one or more processors; one or more memories coupled to the processors and storing instructions that, when executed by the processors, cause the system to: receive transaction text and a transaction zipcode;
execute a rule-based matching module to attempt to identify a merchant;
upon failure of the rule-based matching module, execute an enhanced string distance module to attempt to identify the merchant;
upon failure of the enhanced string distance module, invoke a transformer model selected from an encoder-only model and a decoder-based model; perform candidate filtering using the transaction zipcode;
select a candidate merchant from a merchant database using either cosine similarity between embedding vectors produced by the encoder-only model or string similarity between a generated canonical merchant name produced by the decoder-based model and merchant names in the merchant database;
compute a verification score comprising a similarity score and a confidence score; and
update an enhanced transaction database with enhanced merchant information when the verification score satisfies a threshold.

9. The system of claim 8, wherein the encoder-only model is configured to encode both transaction text and merchant names using a shared encoder architecture and to perform vector search over a merchant index.

10. The system of claim 8, wherein the decoder-based model comprises an encoder-decoder model configured to transform transaction context representations into a generated merchant name.

11. The system of claim 8, wherein the transformer model is a small transformer model with a parameter count less than 20 million parameters.

12. The system of claim 8, wherein the instructions further cause the system to compute negative samples for training the encoder-only model by selecting merchant names with Jaccard similarity greater than 0.75 and less than 1.0 relative to a true merchant name.

13. The system of claim 8, wherein the instructions further cause the system to rank candidate merchants within a constrained candidate pool produced by a text search over merchant data matched to the transaction zipcode.

14. The system of claim 8, wherein the enhanced transaction database stores the generated canonical merchant name, a selected merchant identifier, and the verification score, and the system refrains from presenting a merchant match when the verification score fails to meet the threshold criteria.

15. A non-transitory computer-readable medium storing instructions that, when executed by one or more processors, cause a processing machine to:
obtain a training corpus comprising transaction text and corresponding merchant labels;
train a transformer encoder-only model using contrastive loss to encode both transactions and merchant names into an embedding space and to optimize a similarity margin between positive and negative merchant samples;
train a transformer decoder-based model using cross-entropy loss to generate canonical merchant names from transaction inputs and to produce confidence scores;
deploy the encoder-only model and the decoder-based model in a transaction understanding pipeline that first applies rule-based matching and enhanced string distance matching, and upon failure invokes the encoder-only model or the decoder-based model; and
select and verify a merchant match using a zipcode-constrained candidate pool, a similarity score, and a confidence score.

16. The non-transitory computer-readable medium of claim 15, wherein the contrastive loss comprises a margin-based objective that penalizes high similarity between the transaction embedding and a negative merchant embedding while rewarding high similarity between the transaction embedding and a positive merchant embedding.

17. The non-transitory computer-readable medium of claim 15, wherein the cross-entropy loss is applied token-wise across the generated merchant name sequence and is aggregated to form the confidence score.

18. The non-transitory computer-readable medium of claim 15, wherein the encoder-only model uses an iterative subword unit merging tokenizer with a vocabulary size selected to balance representational capacity and latency, and the transformer decoder-based model uses a byte pair encoding tokenizer with a vocabulary size selected to stabilize generation performance.

19. The non-transitory computer-readable medium of claim 15, wherein deploying the transformer models includes constructing a merchant index for vector search and rebuilding the index upon updates to the encoder-only model, while maintaining a merchant-level text search index for decoder-based model outputs.

20. The non-transitory computer-readable medium of claim 15, wherein selecting and verifying the merchant match includes applying thresholds to both the similarity score and the confidence score to suppress incorrect predictions, and storing enhanced merchant information in an enhanced transaction database upon successful verification.
